(19) United States
(12) Patent Application Publication
(10) Pub. No.: US 2013/0082116 A1
(43) Pub. Date: Apr. 4, 2013

(54) USE OF A COMPOSITION BASED ON THERMOPLASTIC RESIN FOR THE MANUFACTURE OF RAILWAY SLEEPERS

(71) Applicants: Eric Perraud, Courdimanche (FR); Rene Maillot, Jonchery Sur Vesle (FR); Ludovic Hardouin-Duparc, Reims (FR)

(72) Inventors: Eric Perraud, Courdimanche (FR); Rene Maillot, Jonchery Sur Vesle (FR); Ludovic Hardouin-Duparc, Reims (FR)

(73) Assignee: Arkema France, Colombes (FR)

(21) Appl. No.: 13/575,121

(22) PCT Filed: Feb. 22, 2011
(86) PCT No.: PCT/FR2011/050361

§ 371 Date: Dec. 13, 2012

(30) Foreign Application Priority Data
Feb. 23, 2010 (FR) 1051276

(51) Int. Cl. C08L 97/02; E01B 3/44

(52) U.S. Cl. CPC C08L 97/02; E01B 3/44
USPC 238/30; 264/328.1; 238/84

(57) ABSTRACT

The present invention relates to the use of a composition based on thermoplastic resin and on natural fibres, in particular plant fibres, for the manufacture of railway sleepers intended for all means of transport that need to run on rails, in particular trains, trams, and underground trains. The present invention also relates to railway sleepers produced from said composition.

The present invention relates to the use of a composition based on thermoplastic resin and natural fibers, more particularly plant fibers, for the manufacture of railroad ties.

Railroad rails are generally laid on ties or slabs. Railroad ties, with a rectangular parallelepipedal shape, are generally made of oak, pine or spruce, with certain tropical woods also being used. Also known are metal ties, generally made of cast iron or of steel, which provide seating and strength conditions that are similar to those of wooden ties. Their lifetime is greater, but their cost price is much higher and they are noisier. Reinforced-concrete ties are also in use, of various types (monobloc ties, ties composed of two beams joined by a metal spacer). For economic reasons, the concrete tie is gradually replacing the wooden tie employed generally throughout the world from the last century onward. These ties exhibit a great flexibility of use, since their dimensions and their arrangement on the track can be adapted to the constraints of the track in question.

While the static performance of concrete ties is satisfactory, their great rigidity is detrimental to the absorption of the dynamic loads recorded by the passage of trains. Moreover, these concrete ties do not provide a sufficient guarantee of electrical insulation. Lastly, their weight gives rise to a relatively high transport cost.

In order to overcome these problems, rail ties made of essentially polyurethane-based composite material in general are being more and more widely used. The use of composite materials, indeed, has increased greatly in recent years, owing to their excellent mechanical properties, such as a high mechanical strength, a very light weight, or their resistance to degradation over time.

These ties, however, have a high cost, and there is still a need for new compositions based on thermoplastic resin that are for use in composite ties and are able to offer an alternative to the existing ties.

The invention accordingly first provides for the use of a composition comprising at least one thermoplastic material and natural fibers, preferably plant fibers, more particularly cellulosic or lignocellulosic fibers, for the manufacture of railroad ties.

The term “railroad ties” refers, in the sense of the present invention, to the ties for all means of transport that require circulation on rails, more particularly trains, tramways and subways.

The composition comprises 10% to 90% and preferably 25% to 70% by weight of thermoplastic material, relative to the total weight of the composition.

Since thermoplastic materials are less hard than concrete, they offer high compatibility with the ballast and limit the sliding of the ties.

The thermoplastic material is preferably selected from ethylene polymers and copolymers, propylene polymers and copolymers, butylene polymers and copolymers, and polyvinyl chloride and copolymers of polyvinyl chloride. The term “polymer” should be understood in the sense of the present invention in a broad sense, and also includes not only polymers but also copolymers or terpolymers.

In one particular embodiment, the thermoplastic material is selected from a PVC resin or crosslinked polyethylene resin. This ensures that the composition does not exhibit substantial creep or that the composition does not have two rupture modes in aging, ductile and fragile.

As thermoplastic materials suitable for the realization of the invention, mention may also be made of polymers based on polyethylene, more particularly high-density polyethylene, ethylene-propylene copolymers, ethylene-acrylate copolymers, ethylene-vinyl alcohol copolymers, and ethylene-vinyl acetate copolymers, and polypropylene and polybutylene. The acrylate comonomers are generally alkyl(meth)acrylates, for example butyl acrylates.

In order to obtain excellent flame retardancy (self-extinguishing), especially when welding operations and/or rail grinding are carried out in the vicinity of the ties, the thermoplastic resin is advantageously polyvinyl chloride (PVC) or a blend of PVC and a compatible polymer selected from vinyl chloride and vinyl acetate (VC/VA) copolymers or terpolymers or vinyl chloride and acrylic derivative (VC/AD) copolymers or terpolymers, thermoplastic polyurethanes (TPU), thermoplastic polyether esters, ethylene/vinyl monomer (EVA) copolymers, ethylene/vinyl monomer/carbonyl terpolymers, acrylic elastomers which can be processed in the melt state, copolymers containing polyamide blocks and polyether blocks, or polyether-block-amides, chlorinated or chlorosulfonated polyethylenes, ethylene/alkyl (meth)acrylate or (meth)acrylic acid polymers with or without functionalization, MBS core-shell polymers, SBM block terpolymers, PVDF, and powder polyamide resins. According to one preferred embodiment of the invention, the thermoplastic resin used is a polyvinyl chloride (PVC) with a Kwert of between 50 and 80.

The use of polyvinyl chloride also has other advantages over the use of polyolefins. As an example, mention may be made of better resistance to oils and to fats, or better resistance to adverse weather.

In particular, the water absorption of a composition comprising PVC and wood as plant fibers is approximately 1.5%, as against approximately 3% for a composition in which the PVC was replaced by a polyolefin.

Accordingly, the compositions used in the ties exhibit excellent stability over time, especially with regard to their resistance to climatic exposures, more particularly in outdoor exposure.

The impermeability of the composition and its transparency for waves, lastly, allows electrical or electronic elements to be integrated into the ties.

Natural fibers in the sense of the present invention are fibers of animal, plant or mineral origin.

Plant fibers in the sense of the present description are cellulosic or lignocellulosic fibers.

Examples of such fibers include kenaf, cotton, jute, flax, hemp, miscanthus, sorghum, hop, metal, wood or sisal fibers. The plant fibers preferred according to the invention are more particularly wood fibers. In particular, the plant fibers may be composed of ground fibers identical to those developed for particleboards.

The plant fibers according to the invention are preferably lignocellulosic fibers. In particular, the plant fibers preferred according to the invention are fibers obtained from a coniferous wood, which have a higher ratio of length to diameter than deciduous wood.

The composition comprises preferably 5% to 85% or more preferably 30% to 70% by weight of plant fibers, relative to the total weight of the composition.

The plant fibers used in the compositions of the invention preferably have a moisture content of 8% by weight or less. For example, 1% to 8% by weight.

Plant fibers are acknowledged for their reinforcing capacity and their heat and sound insulation capacity. In combination with a thermoplastic matrix, these fibers provide an ecological alternative to more traditional railroad ties, produced from concrete, for example, or exclusively from a polymer obtained from fossil resources.

The composition used in the ties of the invention likewise responds to a need for environmental design. In particular, the plant fibers may be obtained from wood wastes and residues, which are thereby productively utilized, in the same way as for the thermoplastic polymers, which may be obtained from a recycling process.

Similarly, at the end of life, the ties according to the invention are easier to recycle than the ties which may include thermosetting resins, which are difficult to reprocess, or ties comprising glass fibers, which tend to cause abrasion of the equipment employed at the time of their recycling. The wood fibers, furthermore, may be obtained from sustainable forest management schemes, hence lightening the carbon footprint of the composition.

In order to limit CO₂ emissions during transport of ties in accordance with the invention, the product will advantageously be manufactured close to a source of plant fibers, or close to a source of thermoplastic resin. The site used for the production of the ties will ideally have railroad access, for the convenient dispatch of the ties.

The composition used in the ties of the invention exhibits mechanical properties, particularly stiffness, load resistance and impact resistance, which are sufficient to allow it to be applied as a railroad tie.

Very preferably, the composition used in the ties of the invention comprises an equiponderate mixture of thermoplastic material and plant fibers. A composition of this kind gives excellent mechanical properties.

In one particular embodiment, the above-defined composition, the composition referred to as the “matrix”, is coated with a surface layer comprising a thermoplastic resin, a filler, TiO2, an impact additive, and optionally a stabilizer.

This surface layer allows further improvements in the water resistance, frost resistance, UV resistance, weed killer resistance, impact resistance and/or hydrocarbon resistance, more particularly oil resistance, of the matrix composition defined above.

The composition and the surface layer have preferably been obtained by a coextrusion process.

The thermoplastic resin is preferably selected from polyvinyl chloride (PVC) or a blend of PVC and a compatible polymer selected from vinyl chloride and vinyl acetate (VC/VA) copolymers or terpolymers or vinyl chloride and acrylic derivative (VC/AD) copolymers or terpolymers, thermoplastic polyurethanes (TPU), thermoplastic polyether esters, ethylene/vinyl monomer (EVA) copolymers, ethylene/vinyl monomer/carbonyl terpolymers, acrylic elastomers which can be processed in the melt state, copolymers containing polyamide blocks and polyether blocks, or polyether-block-amides, chlorinated or chlorosulfonated polyethylenes, ethylene/alkyl(meth)acrylate or (meth)acrylic acid polymers with or without functionalization, MBS core-shell polymers, SBM block terpolymers, PVDF, and powder polyamide resins. According to one preferred embodiment of the invention, the thermoplastic resin used is a polyvinyl chloride (PVC) with a Kwert of between 50 and 80.

The matrix composition and the surface layer may further comprise one or more additives selected from the following:
one or more plasticizers,
lubricants, such as stearic acid and its esters (including Loxiol® G12 from Cognis), waxy esters (including Loxiol® G70 S from Cognis), polyethylene waxes, paraffin or acrylic lubricants (including Plastistrength® products, especially L1000, from Arkema),
organic or inorganic pigments, such as carbon black or titanium dioxide,
heat and/or UV stabilizers, such as tin, lead, zinc, cadmium, barium or sodium stearates, including Thermolite® from Arkema,
costabilizers such as epoxidized natural oils, more particularly epoxidized soybean oils such as Ecepox® PB3 from Arkema,
antioxidants, for example phenolic, sulfur-containing or phosphitic antioxidants,
fillers or reinforcing agents, more particularly talc, calcium carbonate, mica or wollastonite, glass or metal oxides or hydrates, or else barite,
antistatic agents,
fungicides and biocides,
impact modifiers, such as MBS copolymers, including Clearstrength® C303H from Arkema, and acrylic core-shell modifiers such as Durastrength® products from Arkema,
swelling agents such as azodicarbonamides, azobisisobutyronitrile, and diethyl azobisisobutyrate,
flame retardants, including antimony trioxide, zinc borate, and brominated or chlorinated phosphate esters, which will preferably be added in a mixture with the plant fibers, and
mixtures thereof.

These additives may represent, for example, from 1% to 10% of the total weight of the matrix composition or of the surface layer.

The invention further provides a railroad tie comprising a composition as defined above.

The tie preferably has brushing or graining on the surface to increase its roughness. The tie may also have a longitudinally corrugated base and transverse hollow machining.

The surface of the profile is advantageously convex, to aid the flow of water and prevent freezing problems.

The tie may take the form of a material which may be:
compact,
expanded, to transfer stresses to the ground, or
cellular, thereby allowing, in particular, better cooling of the tie.

When the tie is in a cellular form, the cells may be wholly or partly filled with PVC resin, as for example with expanded PVC resin.

The tie may have in its upper part a bearing plate for receiving the rail, said bearing plate optionally comprising an insulating pad made of rubber, for example, for damping vibrations, and also a mechanical stop, the whole assembly being screwed elastically onto a spiral spring, leaf spring or helical spring, in order to prevent lengthwise sliding. The rail may also be clipped onto the plate in order to prevent the risk of unscrewing linked to vibrations.

In order to enhance the adhesion to the ballast, it is possible to coextrude a flexible PVC-based under-ballast carpet at the same time as the tie itself. The railroad tie may also comprise vertical, horizontal and/or diagonal partitions which are positioned in order to enhance the screw pullout resistance and the compression resistance.

Likewise, in order to improve the lateral resistance, the railroad tie may comprise vertical, horizontal and/or diagonal partitions. The density of the partitions will depend on the target weight of the tie. In order to enhance further the lateral resistance, the tie may have plugs which can act as a spade and which are anchored in the ballast. The tie may also be fitted with a metal or plastic collar in order to prevent corrosion.

In order to improve the distribution of the mechanical load on the tie screw, it is possible to use pins made of PVC resin or polyamide. The pin will also serve as a seal for preventing water infiltration into the tie. In order to prevent moisture being taken off via the edges of the tie, and to prevent animals, more particularly insects, making the tie their home, one or both ends of the tie may be fitted with a cover.

The tie may be composed of one or more profiles obtained by a process of extruding the composition as defined above. Accordingly, the tie may comprise one or more profiled elements which are superposed and fixed by gluing, by screwing or by clipping. The number of profiled elements may vary, so that a range of rail tie dimensions can be accessed with a minimum of tooling. When the tie comprises a matrix and an upper layer, said tie may also be obtained by a coextrusion process.

In order to improve adhesion to the ballast, it is possible, when the tie is produced by an extrusion process, to coextrude a PVC-based under-ballast carpet at the same time as the tie itself.

Accordingly, preferably, the tie has on its lower part a bearing pad, it being possible for the tie and the pad to be obtained by a coextrusion process.

### BRIEF DESCRIPTION OF THE DRAWING

The FIGURE shows a tie in accordance with the invention.

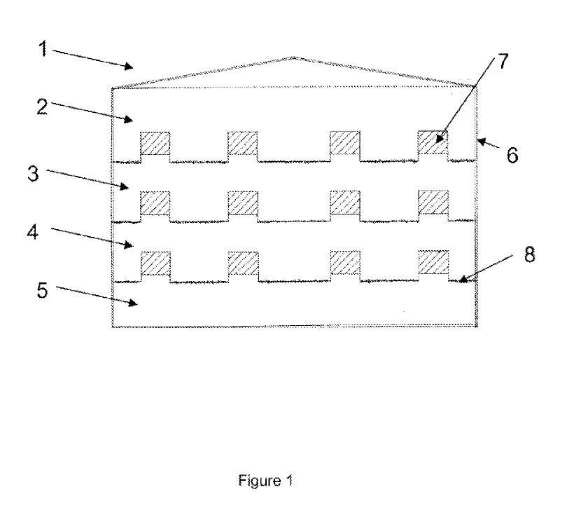

The remainder of the description relates to FIG. 1, but shows a sectional view of a tie 1.

The tie is composed of a plurality of profiled elements 2, 3, 4 and 5. The profiled elements preferably have a shape allowing them to be stacked. The surface of each of these elements may be covered with a surface layer 6, the composition of which has been defined above. Preferably only the parts of the profiled elements 2, 3, 4 and 5 which will eventually be in contact with the ambient air, after assembly of the profiled elements, are covered with a surface layer 6.

In order to facilitate their assembly by gluing, the profiled elements 2, 3, 4 and 5 may comprise grooved parts 8.

Finally, the tie 1 may comprise recesses 7 intended both to lighten the tie 1 but also to facilitate the manufacture of each profiled element 2, 3, 4 or 5.

The tie preferably comprises 5% to 40% and more preferably 20% to 30% of recess, relative to the total volume of the tie 1.

The invention also relates to a method for producing a railroad tie as defined above, in which the thermoplastic material and the natural fibers are mixed and then extruded or injection-molded at a temperature of between 150 and 200° C. to give a profile or granules of said composite.

The mixing of the plant fibers with the thermoplastic material and the extrusion of the profile may be simultaneous.

When an extruder is employed, it is fed, for example, with a screw system for fiber disperser. The extruder may be fed with two gravimetric metering devices: one for the additized or unadditized thermoplastic material and one for the plant fibers.

The fibers will advantageously be compacted in order to prevent bridging in the hopper and in order to increase their bulk density. The extruder comprises a degassing well.

When long ties are to be produced, for switches, for example, it is preferred to use an extrusion process rather than an injection-molding process.

In the method of the invention, the machining and the cutting-out of the ties may take place directly on the extrusion line, after the extrusion itself. Sheets are produced for the rail plate, and recesses are made to allow the insertion of the ballast and to prevent sideways sliding.

The invention is additionally illustrated by the following nonlimiting examples.

### EXAMPLE 1

### Preparation of the PVC Dry Blend

In an FM vertical rapid mixer-heater (from Henschel), Lacovyl S 071 S PVC of KW 58 (from Arkema) is introduced, 5 phr of MC 9003 WP/8 stabilizer (from Baerlocher) are added, and the mixture is heated to 110° C. to give a homogeneous composition (industrial formula FVP 3078 I-C2).

### EXAMPLE 2

### Natural Fiber Types and Preparation of Fibers

Composition A: Lignocel® C 120 wood fibers of spruce origin (from Rettenmeier)

Composition B: Filtracel® EFC 950 C or Arbocel BWW cellulose fibers (from Rettenmeier)

Composition C: MDF particleboard wood fibers (from Isoroy)

Composition D: cutting sawdust wood fibers (from SPPS)

Composition E: short deciduous or long coniferous kraft paper stock fibers (from Tembec)

The fibers are ground on an SMF Atex equipped grinder-micronizer (from Herbold)

The fibers have an average particle size of preferably between 100 microns and 1 mm. The preferred composition is composition A.

### EXAMPLE 3

### Preparation of a PVC/Wood Premix, in Accordance with the Invention

A KM vertical slow mixer-cooler (from Henschel) is charged with 50% by weight of the composition according to example 1 and 50% by weight of one of compositions A to E according to example 2.

### EXAMPLE 4

### Preparation of a PVC/Wood Mixture In Situ in Accordance with the Invention

The composition according to example 1 is metered directly with a K-CL-SFS metering device (from K-Tron), and one of the compositions A to E according to example 2 is metered directly with a K-ML-KV2 metering device (from K-Tron). A small screw disperser (from EMF) is introduced into the extrusion hopper, to prevent the phenomena of bridging and separation within the hopper. In this way, uniform extrusion is produced.

### EXAMPLE 5

### Compounding in Granule Form (Optional Step)

The PVC/fibers blend obtained according to examples 3 or 4 is introduced into the feed hopper of a Weber® 88 extruder. The temperature profile is between 150 and 180° C. The extruder is equipped with a degassing facility (0.2 bar). The melt is chopped at the die head, cooled in air, screened to 5 mm (clusters) and bagged or packed into big bags.

The properties of the resulting product are as follows:
density=1400 kg/m³
moisture absorption=1.5%

### EXAMPLE 6

### Production of a Profile

The PVC/fibers blend according to example 3 (powder), 4 (powder) or 5 (granules) is extruded in a Weber® DS 9 extruder. A colorant masterbatch (from Holland Colours) can be introduced into the feed hopper by means of a metering device (from Plasticolor). The temperature profile is between 150 and 180° C. The extruder is equipped with a degassing facility (0.2 bar). Operation takes place with the screw unencased, and the melt temperature is 185° C. The tooling (from Techno Plast) has the form of the tie, i.e., 16×25 cm.
The extrusion line is equipped with a Techno Plast® calibration bench (vacuum 0.1 bar) and with a Techno Plast® take-off (speed 0.2 m/min).
The profiles are sawn to the desired length of 260 cm.

The properties of the resulting product are as follows:
tensile stress=35 MPa
modulus=5500 MPa
Vicat=90° C.
linear expansion coefficient=0.02 mm/m° C.

### EXAMPLE 7

### Production of a Surface Coextrusion for Aging

Since the hot tooling used for extrusion is symmetrical, it is possible to use a coextrusion block in order to provide the surface with a protective layer.

The layer is applied using a small twin-screw coextruder (from Reifenhauser)

Example of a weather-resistant composition:

| | | | |
|---|---|---|---|
| Lacovyl ® S 110 P | Arkema | PVC KW 67 | 100 |
| R 105 | Dupont | TiO2 | 5 |
| Omyalite ® 95 T | Omya | Filler | 10 |
| Naftosafe ® | Chemson | Ca/Zn stabilizer | 4 |
| Durastrength ® D200 | Arkema | Acrylic impact additive | 6 |

This layer provides mechanical properties, resistance to thermal aging, and protection against moisture.

### EXAMPLE 8

### Production of a Pad Coextrusion for Adhesion to the Ballast

The hot extrusion tooling includes a head plate which allows the coextrusion of an elastomeric pad.

The thickness of the layer is one centimeter and the rigid PVC/flexible PVC adhesion is excellent.

The layer is applied using a small single-screw coextruder (from Lescuyer).

Example of a pad composition:

| | | | |
|---|---|---|---|
| Lacovyl ® S 7015 | Arkema | PVC KW 70 | 100 |
| Jayflex ® DIDP | Exxon | Plasticizer | 80 |
| Chemigum ® | Eliokem | NBR rubber | 15 |
| Lankroflex ® | Akcros | Epoxidized soybean oil | 6 |
| Therm Chek ® | Ferro | Ca/Zn stabilizer | 4 |
| Satintone ® | BASF | Kaolin | 6 |
| Licolub ® | Clariant | Lubricants | 1 |
| Plastistrength ® | Arkema | Processing aid | 1 |
| UN 2016 | Cabot | Carbon black | 1.5 |

The flexible pad allows improved anchorage to the ballast and protects the rigid profile from attrition by the ballast.

### EXAMPLE 9

### Production of Ties

The extrusion line may be equipped in line:
with a brusher (from Wholer) for increasing the surface roughness (pad)
with a graining roller (from Comerio) for increasing the surface roughness (pad)
with a drilling means (from Bosch) for making the holes for receiving the tie screws.

1. In a process for the manufacture of railroad ties, comprising extruding or injection molding a composition, the improvement wherein the composition comprises at least one thermoplastic material and natural fibers.

2. The process of claim 1, wherein the composition comprises 10% to 90% by weight of thermoplastic material, relative to the total weight of the composition.

3. The process of claim 2, wherein the thermoplastic material is ethylene polymers or copolymers, propylene polymers or copolymers, butylene polymers or copolymers, or polyvinyl chloride.

4. The process of claim 1, wherein the natural fibers are plant fibers.

5. The process of claim 1, wherein the composition comprises an equiponderate mixture of thermoplastic material and plant fibers.

6. The process of claim 1, wherein the composition is coated with a surface layer comprising a thermoplastic resin, a filler, TiO₂, an impact additive, and optionally a stabilizer.

7. The process of claim 6, wherein the composition and the surface layer have been obtained by a coextrusion process.

8. A railroad tie comprising a composition as defined in claim 1.

9. The railroad tie of claim 8, composed of one or more profiles obtained by a process of extruding the composition.

10. The railroad tie of claim 8, having an upper part with a bearing plate for receiving a rail, said bearing plate optionally comprising an insulating pad.

11. The railroad tie of claim 8, having a lower part with a bearing pad.

12. The railroad tie of claim 11, wherein the tie and the pad have been obtained by a coextrusion process.

13. The railroad tie of claim 8, in the form of a compact, expanded or cellular material.

14. The process of claim 4, wherein the plant fibers are wood fibers.

15. The process of claim 1, wherein the natural fibers are cellulosic or lignocellulosic fibers.
